(19) United States
(12) Patent Application Publication
(10) Pub. No.: US 2022/0183337 A1
(43) Pub. Date: Jun. 16, 2022

(54) SPRAY-DRIED POWDERS

(71) Applicant: ZOOMESSENCE, INC., Hebron, KY (US)

(72) Inventors: Charles Pershing BEETZ, Butler, KY (US); Daniel Michael Schlipf, Edgewood, KY (US); Jason Zhixin Li, Union, KY (US)

(21) Appl. No.: 17/598,199

(22) PCT Filed: Mar. 25, 2020
(86) PCT No.: PCT/US2020/024600

§ 371 Date: Sep. 24, 2021

Related U.S. Application Data
(60) Provisional application No. 62/823,593, filed on Mar. 25, 2019.

(51) Int. Cl. A23L 27/00; C08L 3/04; A23L 27/12; A23L 29/212

(52) U.S. Cl. CPC A23L 27/72; C08L 3/04; A23V 2002/00; A23L 29/212; C08L 2205/14; A23L 27/12

(57) ABSTRACT

Spray-dried encapsulated flavor powders are described, having particles that are large sized, highly flowable, fully dense, and highly dispersible and/or soluble, with low surface area to volume ratio, and high bulk density. Such flavor powders provide high retention of flavor components, and are advantageously produced by low temperature spray drying processes, e.g., single-step processes in which drying is intensified by techniques variously described herein.

### CROSS-REFERENCE TO RELATED APPLICATION

The benefit under 35 USC § 119 of U.S. Provisional Patent Application 62/823,593 filed Mar. 25, 2019 is hereby claimed. The disclosure of such application is hereby incorporated herein by reference, in its entirety, for all purposes.

### FIELD

The present disclosure relates generally to spray-dried flavor powders, and more specifically to single step spray-dried/single atomization encapsulated flavor powders having superior use and performance characteristics.

### DESCRIPTION OF THE RELATED ART

In the field of spray-dried encapsulated flavor powders for use as additives and ingredients in food and/or beverage products, spray-dried flavor powders are commercially produced that have a wide variety of disadvantageous characteristics. These deficiencies include susceptibility to oxidation, decomposition and/or degradation of the flavor component, poor dispersibility and/or solubility of the flavor powder in liquid media, small powder particle size, high void volume in the powder particles that necessitates correspondingly larger amounts of the powder in use, and poor flowability that creates difficulties in dispensing and processing the flavor powder, as well as poor retention of the active flavor component.

In consequence, the art continues to seek improvements in spray-dried encapsulated flavor powders.

### SUMMARY

The present disclosure relates to spray-dried encapsulated flavor powders that in relation to spray-dried encapsulated flavor powders of the prior art have combined properties of being large, highly flowable, fully dense, highly dispersible and/or soluble, with low surface area to volume ratio and high bulk density, as well as high retention of the active flavor component.

In various aspects, the disclosure relates to a spray-dried encapsulated flavor powder, e.g., a single-step spray-dried encapsulated flavor powder, including one or more encapsulated flavor ingredients, and characterized by one or more, and preferably all, of the following characteristics:

(A) a Dispersing Medium Dissolution Time of less than 60 seconds;

(B) a Dispersing Medium Dispersion Time of less than 15 seconds;

(C) a Particle Size Distribution in which at least 75% of particles in the powder have a particle size of at least 80 μm;

(D) a Surface Area (μm²) To Volume (μm³) Ratio of the particles of the powder that is in a range of from 0.01 to 0.03;

(E) a Particle Void Volume in the particles of the powder that is less than 10% of the total particle volume;

(F) a Bulk Density of the particles of the powder that is in a range of from 22 to 40 lb/ft³, and

(G) an Angle Of Repose of the powder that does not exceed 40°, optionally wherein when the spray-dried powder contains an encapsulated oil, the Surface Oil Percentage is less than 1.5%.

In another aspect, the disclosure relates to a spray-dried encapsulated flavor powder, e.g., a single step spray-dried encapsulated flavor powder, having a flavor component retention of at least 90%, which may additionally be characterized by any of the foregoing characteristics (A)-(G) and/or the Surface Oil Percentage specified above.

Further aspects of the disclosure relate to such spray-dried encapsulated flavor powders, characterized by any two, three, four, five, six, or all seven, of the above-described characteristics (A)-(G), optionally wherein when the spray-dried powder contains an encapsulated oil, the ratio of the amount of surface oil to the amount of encapsulated oil, in corresponding amount units, is less than 1.5%.

In various aspects, the disclosure relates to single-step spray-dried encapsulated flavor powders as described above, in which the one or more encapsulated flavor ingredients is selected from the group consisting of almond, orange, lemon, lime, tangerine, amaretto, anise, pineapple, coconut, pecan, apple, banana, strawberry, cantaloupe, caramel, cherry, blackberry, raspberry, ginger, boysenberry, blueberry, vanilla, honey, molasses, wintergreen, cinnamon, cloves, butter, buttercream, butterscotch, coffee, tea, peanut, cocoa, nutmeg, chocolate, cucumber, mint, toffee, eucalyptus, grape, raisin, mango, peach, melon, kiwi, lavender, licorice, maple, menthol, passionfruit, pomegranate, dragon fruit, pear, walnut, peppermint, pumpkin, root beer, rum, and spearmint.

In various further aspects, the disclosure relates to single-step spray-dried encapsulated flavor powders as variously described above, in which the encapsulated flavor is encapsulated by a carrier material selected from the group consisting of carbohydrates, proteins, lipids, waxes, cellulosic material, sugars, starches, natural and synthetic polymeric materials.

Other aspects, features and embodiments of the disclosure will be more fully apparent from the ensuing description and appended claims.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a graphical rendering of temperature of droplets of sprayed feedstock as a function of percentage solids of the droplets during the spray drying process producing spray-dried encapsulated flavor powder particles, showing the progression of drying stages experienced by droplets in conventional high temperature spray drying processes (“Spray Dry Powder”) and droplets spray-dried at low temperature to produce the spray-dried encapsulated flavor powder of the present disclosure (“CoolZoom® Powder”).

FIG. 2 is an electron photomicrograph of a spray-dried encapsulated flavor powder particle produced by conventional high temperature spray drying, at 2500× magnification, showing the hollow character (central void) of such particle.

FIG. 3 is an electron photomicrograph of a spray-dried encapsulated flavor powder particle of the present disclosure, at 1510× magnification, showing the dense character of such particle, as free from large-scale voids such as shown in the powder particle of FIG. 2.

FIG. 4 is a graph of percentage composition of lemon oil, showing the flavor components in such flavor oil.

FIG. 5 is a graph of percentage composition of lemon oil, showing the flavor components in such flavor oil, as contained initially in lemon oil that was spray-dried with carrier (Lemon Oil), and as encapsulated in a spray-dried powder of the present disclosure (Lemon DriZoom).

FIG. 6 is a pie graph, showing weight percent of flavor components of a fruit punch flavor material.

FIG. 7 is a pie graph, showing weight percent of flavor components of the fruit punch flavor material of FIG. 6, as encapsulated in a spray-dried powder of the present disclosure.

FIG. 8 is a schematic representation of a spray drying system that may be employed for production of a spray-dried encapsulated flavor powder of the present disclosure.

FIG. 9 is a schematic representation, in breakaway view, of a portion of the spray drying process system of FIG. 8, illustrating an enhancement of the intensity of spray drying process by inducing localized turbulence in the interior volume of the spray drying vessel in such system.

FIG. 10 is a schematic representation of another spray drying apparatus that may be employed to produce the encapsulated flavor spray-dried powder of the present disclosure, in which the apparatus includes an array of turbulent mixing nozzles on the spray drying chamber wall, configured for injection of transient, intermittent turbulent air bursts into the main fluid flow in the spray drying chamber.

FIG. 11 is a schematic representation of a further spray drying apparatus that may be employed to produce the encapsulated flavor spray-dried powder of the present disclosure.

### DETAILED DESCRIPTION

The present disclosure relates to spray-dried encapsulated flavor powders, e.g., single step spray-dried encapsulated flavor powders, that in relation to spray-dried encapsulated flavor powders of the prior art have combined properties of being large, highly flowable, fully dense, and highly dispersible and/or soluble, with low surface area to volume ratio and high bulk density, as well as high retention of the active flavor component.

As used herein, the term “flavor” refers to a substance that is used to produce a sensation of taste, or of taste and aroma in combined effect. The flavor may in subsequent use be an additive ingredient for foods and/or beverages, for enhancement of their qualities and appeal.

The term “single step spray-dried” in reference to powders of the present disclosure means that the powder is produced solely by low temperature spray drying (<110° C. inlet temperature of drying fluid flowed to the spray drying vessel) involving contacting of atomized particles, generated by a single source atomizer, of a spray-dryable material with drying fluid to effect solvent removal from the spray-dryable material to a dryness of less than 5wt% of solvent, based on total weight of the spray-dried powder, without any post-spray drying processing, e.g., fluidized bed treatment, coating, or chemical reaction. The “single source atomizer” specified in such definition refers to a single atomizer that receives one spray-dryable material from a corresponding feed source, i.e., the atomizer does not concurrently receive different spray-dryable materials from different feed sources.

The various measurement/determination techniques applicable to various characteristics of the spray-dried encapsulated flavor powders of the present disclosure are described below.

The Dispersing Medium Dissolution Time

The Dispersing Medium Dissolution Time measures the rate of spray-dried powder dissolution in water as the dispersing medium. The procedure for determining the Dispersing Medium Dissolution

Time is as follows:
1) 2 grams of the spray-dried powder are dropped into 100 grams of water (in a 150 mL beaker) while the water is being stirred with a mixer at 250 RPM at room temperature.
2) The brix measurement (a measurement of dissolved solids in an aqueous solution, as determined by Milwaukee Instruments MA871 Digital Brix Refractometer) of the powder and water composition is measured as the powder begins to dissolve in the water and thereafter at 15 second intervals, with all measurements recorded.
3) When the brix value equilibrates without changing for 1 minute, that time value is reported as the dissolution value.
4) Method note: mixing is increased at 2 minutes and 4 minutes from 250 RPM to 500 RPM and 1000 RPM respectively to ensure complete mixing.

The Dispersing Medium Dispersion Time

The Dispersing Medium Dispersion Time measures the amount of time required to disperse the spray-dried powder in water as the dispersing medium. The procedure for determining the

Dispersing Medium Dispersion Time is as follows:
1) 2 grams of the spray-dried powder are dropped into 100 grams of water (in a 150 mL beaker) while the water is being stirred at 250 RPM at room temperature.
2) Mixing is increased at 2 minutes and 4 minutes from 250 RPM to 500 RPM and 1000 RPM respectively to ensure complete mixing.
3) The Dispersing Medium Dispersion Time is recorded as the time required for all powder to sink below the surface of the water in the agitated beaker. Time is started upon contact of the powder with the water.

Particle Size Distribution

Particle Size Distribution of the spray-dried powder is measured by a Beckman Coulter LS 13 320 particle size analyzer providing a volumetric distribution output.
1) Approximately 1 gram of the spray-dried powder is loaded into a sample tube.
2) The Beckman Coulter LS 13 320 vacuums the powder through the analysis chamber according to the manufacturer's protocols.
3) Laser diffraction data is interpreted via Fraunhofer method and reported as a volumetric distribution.
4) Particle size is reported as the median value (d50) from the distribution.

Surface Area (μm²) to Volume (μm³) Ratio

The surface area to volume ratio describes the amount of surface area (in units of μm²) to which a particle is exposed, relative to the volume (mass) (in units of μm³) of the material in the particle. Reduced particle surface area per unit volume reduces the available area for product oxidation. Accordingly, to reduce the Surface Area to Volume ratio, it is preferred to increase the diameter of the particle as the value is proportional to

$$\frac{Surface Area}{Volume} ∼ \frac{{r}^{2}}{{r}^{3}} .$$

The Surface Area to Volume Ratio is calculated using the diameter (particle size value) of the particle generated from the particle size distribution. The median (d50) value is used for the surface area/volume calculation assuming a spherical particle.

$$\frac{Surface Area}{Volume} = \frac{4 * π * {r}^{2}}{\frac{4}{3} π {r}^{3}} .$$

Particle Void Volume

Particle Void Volume is determined as a calculated percent of the volume taken up by any air pockets inside a particle. The Particle Void Volume measurement relies on a scanning electron microscope (SEM) cross section image to see the internal cross section of a particle for measurement. The Particle Void Volume value is reported as a percentage, calculated by the volume of the air pockets/volume of the entire particle defined by the external particle boundaries.

The procedure for determining Particle Void Volume is as follows:
1) Approximately 100 mg of powder is thoroughly mixed in 5 mL of epoxy resin.
2) The resin is cast in a mold (Electron Microscopy Sciences part number 70900) and allowed to cure for 1 day.
3) After curing, the mold is scored and snapped in half to present a clean face of cross sectioned particles embedded in the resin.
4) Microscope imaging analysis is performed between 0.1 and 1 KX at 5 KV. From the cross section, image analysis software (Image J, National Institute of Health) is used to measure the cross-sectional diameter of the particle and any cross section of internal voids.
5) The void volume is determined by dividing the sum of void volumes (calculated from V=4/3*π*r^3) by the volume of the entire particle and multiplying by 100.

Bulk Density

Bulk Density of the particles of the powder is measured by ASTM standard. The procedure is as follows:
1) A calibrated Copley BEP2 25 mL density cup is tared on a scale.
2) The cup is filled until overflowing and the excess is scraped off
3) The powder + cup is re-weighed
4) The weight in grams is divided by 25 mL (volume of cup) and multiplied by 62.428 to convert into pounds/ft^3.

Angle of Repose

The Angle of Repose, which also is referred to as the Flowability Index, is determined for the spray-dried powder as follows:
1) A Copley BEP2 flow meter is used to measure the angle of repose of a cone formed by powder flowing through a funnel onto a catch plate.
2) The funnel is fasted 75 mm above catch plate using an alignment tool, with the shutter closed.
3) Approximately 30 g of powder is weighed out and placed in the funnel for analysis.
4) The powder is rapidly released, allowing all powder to drop.
5) For poorly flowable products, a stirring attachment is used with a slow, smooth stirring motion.
6) The height (h) and diameter (d) of the cone generated on the catch plate is measured. The Angle of Repose then is calculated using the following formula:

$$tan 0 = \frac{h}{0.5 d} , \\ or$$

$$θ = [ {tan}^{- 1} ( \frac{h}{0.5 d} ) ] ( \frac{180}{π} )$$

Table 1 below correlates the generalized flow properties with specific values of the Angle of Repose.

TABLE 1

| Flow Property | Angle of Repose |
|---|---|
| Excellent | <30 |
| Good | 31-35 |
| Fair- aid not needed | 36-40 |
| Passable- may hang up | 41-45 |
| Poor- must agitate, vibrate | 46-53 |
| Very poor- Reject | >53 |

Surface Oil Percentage

The Surface Oil Percentage Surface Oil/Total Powder Weight Ratio is a measurement in which surface oil is washed from the powder by hexane wash and the oil content is quantitated by gas chromatography-mass spectrometry (GC-MS). The concentration of washed oil in hexane is multiplied by the weight of hexane used, divided by weight of powder washed, and multiplied by 100 to get a surface oil percentage. The procedure is as follows:
1) 35 g of the spray-dried powder is placed in a cellulose thimble (Whatman Grade 603, 33 mm×100 mm)
2) The thimble is then placed in the Soxhlet extraction apparatus.
3) 100 g of hexane is weighed and placed into a 250 mL flat bottom flask and connected to the Soxhlet apparatus.
4) The flask is heated on a hot plate to boiling and concurrently stirred with a magnetic stir bar. The hexane allowed to reflux for 4 hrs.
5) Following the 4 hrs. refluxing operation, the flask is allowed to cool. Once cooled, an aliquot of the hexane is recovered for GC-MS analysis.

Quantitation Method:
1) A 5-pt standard curve is created using the flavor set being analyzed to determine a linear correlation between the detector response and surface oil wash concentration.
2) The percent surface oil is determined according to the following formula:

$$Surface Oil = \frac{Concentration of Wash * 100 grams hexane}{35 grams powder}$$

Dryness of the single pass spray-dried encapsulated flavor powders of the present disclosure is measured to the exclusion of any flavor oils that are present in the spray-dried powder, with such dryness identifying the extent to which the product powder is free from water and other volatile solvent media. Preferably, the dryness of the single pass spray-dried encapsulated flavor powder is characterized by no more than 5% by weight of water and/or other volatile solvent media in the powder, more preferably no more than 2% by weight, even more preferably no more than 1% by weight, and most preferably less than 0.75% by weight, based on the total weight of the powder.

In various specific embodiments, the weight of water and/or other volatile solvent media in the spray-dried powder, based on total weight of the powder, may be less than 5%, 4.8%, 4.6%, 4.5%, 4.4%, 4.2%, 4%, 3.8%, 3.6%, 3.5%, 3.4%, 3.2%, 3%, 2.8%, 2.6%, 2.5%, 2.4%, 2.2%, 2%, 1.8%, 1.6%, 1.5%, 1.4%, 1.3%, 1.2%, 1.1%, 1%, 0.9%, 0.8%, 0.7%, 0.6%, 0.5%, 0.4%, 0.3%, 0.2%, 0.1%, or 0.05%, depending on the processing of the spray-dried powder and the subsequent use requirements for the powder.

The present disclosure provides spray-dried encapsulated flavor powders having superior use and performance characteristics in a variety of respects, as is evident from the variety of characteristics described herein.

The spray-dried encapsulated flavor powders of the present disclosure provide a high level of retention of original flavor components in the powder, with flavor component retention levels that may be at least 90%, 91%, 92%, 93%, 94%, 35%, 96%, 97%, 98%, 98.5%, 99%, 99.5%, or 99.9% retention in various embodiments, based on weight of the flavor components in the spray-dryable material from which the spray-dried encapsulated flavor powder is produced. The flavor component may comprise single or multiple flavor compounds and ingredients. In such respect, the spray-dried encapsulated flavor powders of the present disclosure are characterized by a “fingerprint” of the flavor component that is highly congruent with the flavor component compounds and ingredients in the source material from which the powder has been formed.

The disclosure relates in one aspect to a spray-dried encapsulated flavor powder, e.g., a single-step spray-dried encapsulated flavor powder, including one or more encapsulated flavor ingredients, and characterized by one or more, and preferably all, of the following characteristics:

(A) a Dispersing Medium Dissolution Time of less than 60 seconds;

(B) a Dispersing Medium Dispersion Time of less than 15 seconds;

(C) a Particle Size Distribution in which at least 75% of particles in the powder have a particle size of at least 80 μm;

(D) a Surface Area (μm²) To Volume (μm³) Ratio of the particles of the powder that is in a range of from 0.01 to 0.03;

(E) a Particle Void Volume in the particles of the powder that is less than 10% of the total particle volume;

(F) a Bulk Density of the particles of the powder that is in a range of from 22 to 40 lb/ft³, and

(G) an Angle Of Repose of the powder that does not exceed 40°,

optionally wherein when the spray-dried powder contains an encapsulated oil, the Surface Oil Percentage is less than 1.5%.

Thus, the spray-dried encapsulated flavor powders of the present disclosure may be characterized by any one of characteristics (A)-(G) and/or the Surface Oil Percentage of less than 1.5%.

The spray-dried encapsulated flavor powders of the present disclosure are most preferably characterized by all of the above characteristics (A)-(G) and the additional characteristic that when the spray-dried powder contains an encapsulated oil, the Surface Oil Percentage is less than 1.5%.

In the spray-dried encapsulated flavor powder, e.g., single-step spray-dried encapsulated flavor powder, of the disclosure, the one or more encapsulated flavor ingredients may be of any suitable type, and may for example comprise at least one selected from the group consisting of almond, orange, lemon, lime, tangerine, amaretto, anise, pineapple, coconut, pecan, apple, banana, strawberry, cantaloupe, caramel, cherry, blackberry, raspberry, ginger, boysenberry, blueberry, vanilla, honey, molasses, wintergreen, cinnamon, cloves, butter, buttercream, butterscotch, coffee, tea, peanut, cocoa, nutmeg, chocolate, cucumber, mint, toffee, eucalyptus, grape, raisin, mango, peach, melon, kiwi, lavender, licorice, maple, menthol, passionfruit, pomegranate, dragon fruit, pear, walnut, peppermint, pumpkin, root beer, rum, and spearmint.

In various embodiments, the one or more encapsulated flavor ingredients comprise at least one flavor oil.

The spray-dried encapsulated flavor powders of the present disclosure may comprise any suitable carrier material as an encapsulant for the corresponding flavor ingredient(s) of the powder. Illustrative examples of carrier materials include, without limitation, at least one selected from among carbohydrates, proteins, lipids, waxes, cellulosic material, sugars, starches, natural and synthetic polymeric materials. Specific materials that may be advantageously employed include maltodextrin, corn syrup solids, modified starches, gum arabic, modified celluloses, gelatin, cyclodextrin, lecithin, whey protein, and hydrogenated fat. Preferably, the carrier material is a modified starch material. Various spray drying carriers are identified in Table 2 below.

TABLE 2
Spray Drying Carriers

Polysaccharides:
starches, modified food starches, native starches, maltodextrins,
alginates, pectins, methylcellulose, ethylcellulose,
hydrocolloids, inulin, carbohydrates, mono-, di- and tri-
saccharides, soluble fibers, polydextrose
Proteins:
animal proteins, plant proteins, caseinates, gelatins, soy proteins,
pea proteins, whey proteins, milk proteins
Gums:
guar gum, xanthan gum, acacia gum (gum arabic),
gellan gum, and caragenan
Esters:
Polysorbates, stearic acid esters, oleic acid esters
Lipids and waxes:
coconut oil, medium chain triglyceride (MCT) oils, vegetable oils,
sunflower oils, palm oils, caruba waxes, bee waxes

In various embodiments, the spray-dried encapsulated flavor powders of the present disclosure may be characterized by a Dispersing Medium Dissolution Time of less than 45, 40, 35, 30, 25, 20, 15, 12, 10, 8, 7, 6, or 5 seconds.

In various embodiments, the spray-dried encapsulated flavor powders of the present disclosure may be characterized by a Dispersing Medium Dispersion Time of less than 15, 14, 13, 12, 11, 10, 9, 8, 7, 6, 5, 4, 8, 2, or 1 seconds.

In specific embodiments, the spray-dried encapsulated flavor powders of the present disclosure may have a Particle Size Distribution in which at least 80%, 85%, 88%, 90%, 91%, 92%, 93%, 94%, or 95% of particles in the powder have a particle size of at least 80 μm. In other embodiments, the spray-dried encapsulated flavor powders of the present disclosure may have a Particle Size Distribution in which at least 80%, 85%, 88%, 90%, 91%, 92%, 93%, 94%, or 95% of particles in the powder have a particle size of at least 85 μm, 90 μm, 95 μm, 100 μm, 110 μm, or 120 μm, or a particle size in a range whose endpoints are any of 80 μm, 85 μm, 90 μm, 95 μm, 100 μm, 110 μm, and 120 μm, with the proviso that the lower end point value of such range is less than the upper end point value of such range. In still other embodiments, the spray-dried encapsulated flavor powders of the present disclosure may have a median particle size, or alternatively an average particle size, that is greater than 100 μm.

Spray-dried encapsulated flavor powders of the present disclosure may in various embodiments have a Particle Void Volume that is less than 10%, 9%, 8%, 7%, 6%, 5%, 4%, 3%, 2.5%, 2%, or 1%, of the total particle volume.

In various embodiments, the Bulk Density of the particles of the spray-dried encapsulated flavor powders of the present disclosure may be in a range of from 22 to 40 lb/ft³, or more preferably in a range of from 25 to 38 lb/ft³.

In various embodiments, the spray-dried encapsulated flavor powders of the present disclosure may have an Angle of Repose that does not exceed 40°, more preferably does not exceed 35°, and most preferably does not exceed 30°.

The spray-dried encapsulated flavor powders of the present disclosure are formed by low temperature spray drying (<110° C. inlet temperature of spray drying vessel) in which the drying operation is carried out to yield powder characterized by the various characteristics described herein.

Preferably, the spray drying operation is conducted as a single step spray drying operation to form corresponding single step spray-dried encapsulated flavor powders.

The spray drying operation may advantageously be carried out under drying intensification conditions in which localized turbulence is generated in the drying fluid in the spray drying vessel to enhance mass transfer of water and other volatile solvent species from the wet atomized droplets in the spray drying vessel to the drying fluid, and produce powders with the performance characteristics described herein.

Illustrative process conditions useful in the production of such powders are described more fully hereinafter, with reference to illustrative spray drying systems that may be used for such purpose.

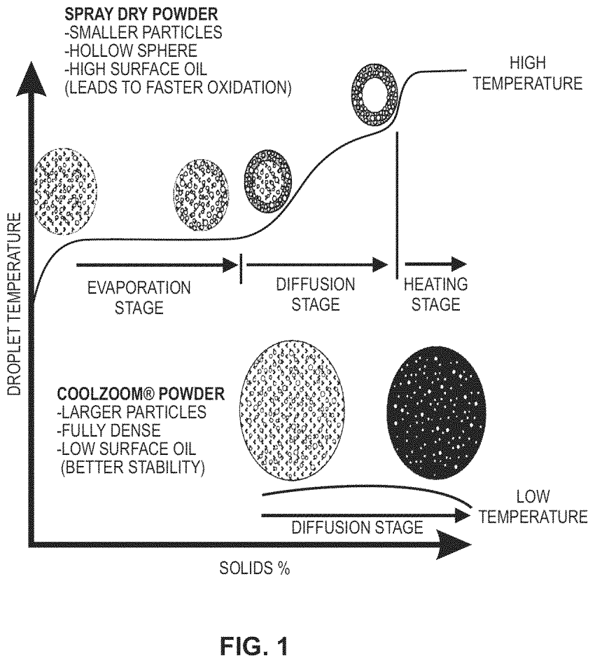

Referring now to the drawings, FIG. 1 is a graphical rendering of temperature of droplets of sprayed feedstock as a function of percentage solids of the droplets during the spray drying process producing spray-dried encapsulated flavor powder particles, showing the progression of drying stages experienced by droplets in conventional high temperature spray drying processes (“Spray Dry Powder”) and droplets spray-dried at low temperature to produce the spray-dried encapsulated flavor powder of the present disclosure (“CoolZoom® Powder”).

As shown in FIG. 1, the conventional high temperature Spray Dry Powder, which may be produced by spray drying with inlet temperatures in the spray dryer of 380-400° F., progresses through a solvent evaporating stage, diffusion stage, and heating stage, in the course of which the feedstock material droplets are subjected to high temperatures that produce smaller particles, hollow spheres, and when the encapsulated flavor comprises a flavor oil, high surface oil formations.

By contrast, the spray-dried encapsulated flavor powder of the present disclosure, which is spray-dried by spray drying with inlet temperatures in the spray dryer that are below 110° C., produce larger particles that are fully dense, and have low surface oil content, as a result of low temperature processing in the diffusion stage.

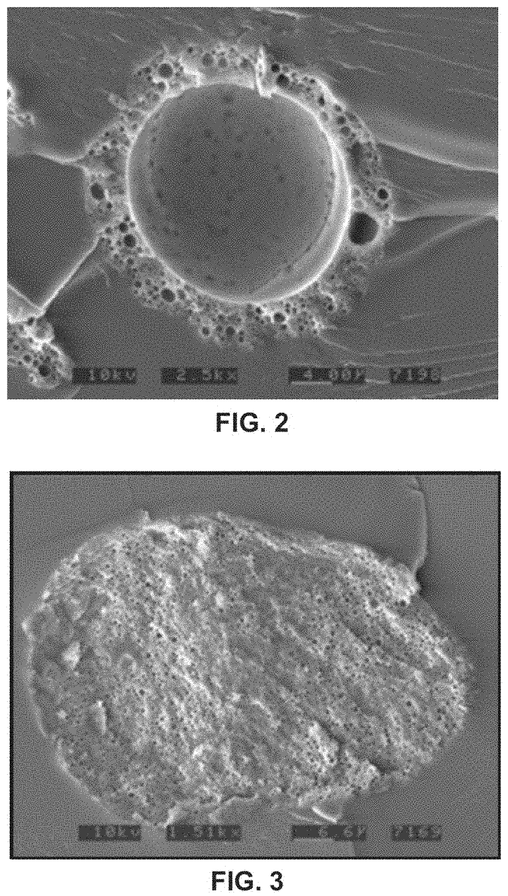

FIG. 2 is an electron photomicrograph of a spray-dried encapsulated flavor powder particle produced by conventional high temperature spray drying, at 2500× magnification, showing the hollow character (central void) of such particle. The encapsulated flavor is Valencia orange oil, and the spray-dried powder particle was produced by spray drying at an inlet temperature in the spray dryer of 380-400° F. As shown in the photomicrograph, the powder particle was of hollow character, meaning that a substantial portion of the overall particle volume was constituted by void volume.

FIG. 3 is an electron photomicrograph of a spray-dried encapsulated flavor powder particle of the present disclosure, at 1510× magnification, showing the dense character of such particle, as free from large-scale voids such as shown in the powder particle of FIG. 2. The encapsulated flavor is Valencia orange oil, and the spray-dried powder particle was produced by spray drying at inlet temperature in the spray dryer of 190-210° F., in accordance with the present disclosure.

It therefore is evident from a comparison of FIGS. 2 and 3 that while the spray-dried encapsulated flavor powder particle produced by conventional high temperature spray drying (FIG. 2) is generally spherical in form with an essentially hollow character, the spray-dried encapsulated flavor powder particle of the present disclosure is of a fully dense character, free of large-scale voids, and is non-spherical in form, being of elongate character.

Accordingly, spray-dried encapsulated flavor powders of the present disclosure may additionally be distinguished from spray-dried encapsulated flavor powder particle produced by conventional high temperature spray drying, by shape eccentricity, wherein powders produced by conventional high temperature spray drying have eccentricity values that may be on the order of 0 to 0.55 when powder particles are characterized by automated image processing and analysis techniques, and wherein powders of the present disclosure have average eccentricity values that may be at least 0.70, and may for example be in a range of from 0.70 to 0.95, from 0.75 to 0.95, from 0.80 to 0.95, or in other suitable range of eccentricity values.

As used in such context, the eccentricity value of a spray-dried particle may be determined as eccentricity E=\sqrt{(a²−b²)}/a, wherein a is the length of the semi-major axis of the particle when viewed in two-dimensional view, and b is the semi-minor axis of the particle when viewed in two-dimensional view. By analysis of a representative sample of the spray-dried powder, an average eccentricity E may be determined for the powder, as a characteristic thereof.

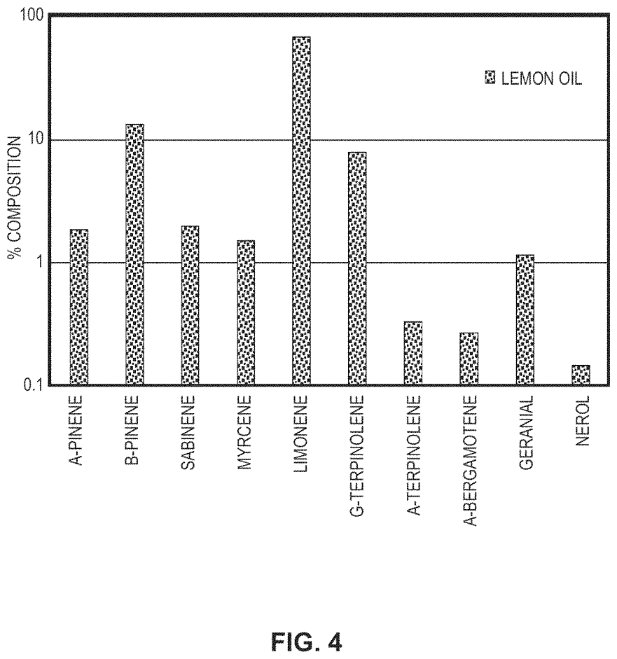

FIG. 4 is a graph of percentage composition of lemon oil, showing the flavor components in such flavor oil, as including a-Pinene, b-Pinene, Sabinene, Myrcene, Limonene, g-Terpinolene, a-Bergamotene, Geraniol, and Nerol.

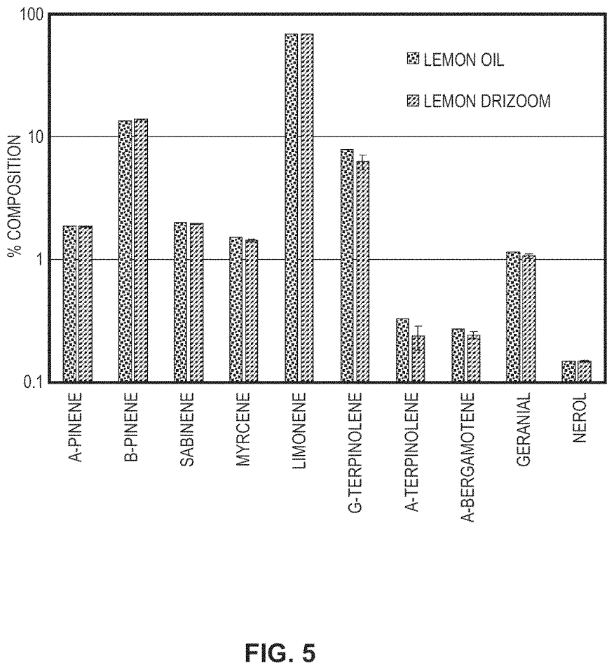

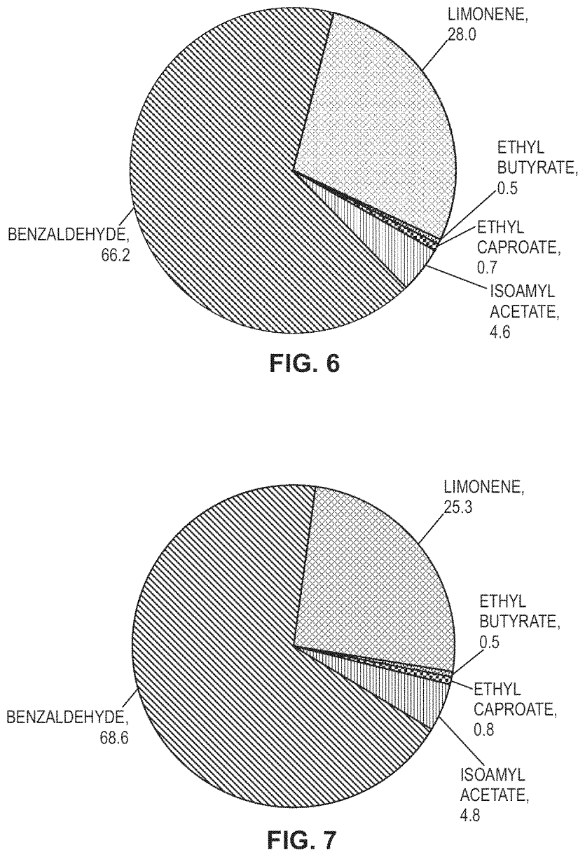

FIG. 5 is a graph of percentage composition of lemon oil, showing the flavor components in such flavor oil that are also shown in the graph of FIG. 4. FIG. 5 shows the various flavor components as initially contained in lemon oil (Lemon Oil) that was spray-dried with carrier, and as encapsulated in a spray-dried powder of the present disclosure (Lemon DriZoom). As shown by the close congruence of the pairs of bars for the flavor ingredients (original feedstock oil, and spray-dried encapsulated flavor powder), the spray-dried powder of the present disclosure achieve a high level of retention of each of the ingredients of the initial flavor oil, namely, a-Pinene, b-Pinene, Sabinene, Myrcene, Limonene, g-Terpinolene, a-Bergamotene, Geraniol, and Nerol.

FIG. 6 is a pie graph, showing weight percent of flavor components of a fruit punch flavor material. The fruit punch flavor material contained 28% limonene, 66.2% benzaldehyde, 4.6% isoamyl acetate, 0.7% ethyl caproate, and 0.5% ethyl butyrate. This fruit punch flavor material was spray-dried t inlet temperature in the spray dryer at temperature below 110° C. to produce an encapsulated flavor powder of the present disclosure, whose composition is shown in FIG. 7, as containing 25.3% limonene, 68.6% benzaldehyde, 4.8% isoamyl acetate, 0.8% ethyl caproate, and 0.5% ethyl butyrate. Accordingly, the encapsulated flavor powder encapsulating the fruit punch flavor material achieved a 97% retention level for the components of the original blend that was spray-dried to produce the powder.

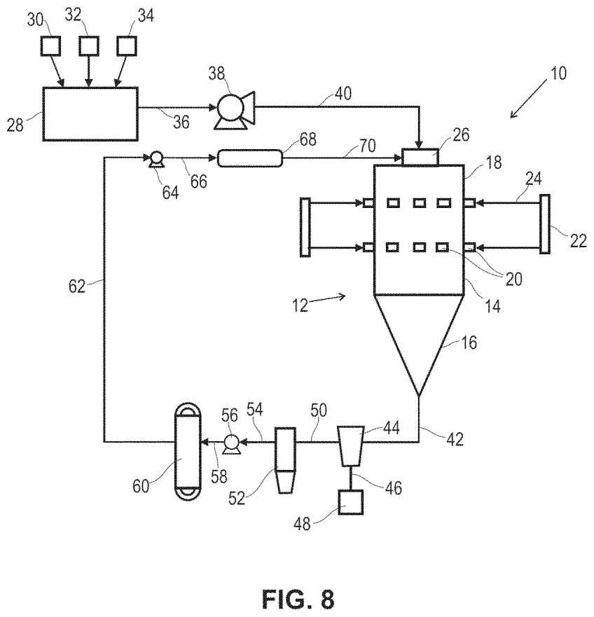

FIG. 8 is a schematic representation of an illustrative spray drying system that may be employed for production of a spray-dried encapsulated flavor powder of the present disclosure.

As shown, the spray drying process system 10 comprises a spray dryer 12 including a spray drying vessel 14 having an upper cylindrical portion 18 and a downwardly convergent conical shaped lower portion 16. The spray drying vessel 14 in this embodiment is equipped with an array of puffer jets 20 installed in two circumferentially extending, longitudinally spaced apart rows in which each puffer jet is circumferentially spaced from the adjacent puffer jets in the row. Each of the puffer jets in the respective rows is arranged to be supplied with secondary drying fluid by the secondary fluid feed lines 24 associated with the source structure 22, which may extend circumferentially around the spray drying vessel 14, so that each of the puffer jets is connected with a secondary fluid feed line 24 in the same manner as the puffer jets shown at opposite sides of the spray drying vessel 14 in the system as depicted in FIG. 1. The puffer jets are utilized to induce localized turbulence in the drying fluid in the interior volume of the spray drying vessel.

The spray-dried encapsulated flavor powder of the present disclosure may be produced using a spray drying vessel that does not employ such puffer jets or other devices to induce localized turbulence in the drying fluid, but such devices may afford an intensification of the drying of the droplets of the spray-dryable material that is introduced into the interior volume of the vessel that may be highly advantageous in producing spray-dried encapsulated flavor powders that are characterized by the various characteristics herein described (the aforementioned characteristics (A)-(G), as well as the Surface Oil Percentage characteristic discussed above as being applicable when the spray-dried powder contains an encapsulated flavor oil in the flavor component).

In the FIG. 8 system, the secondary fluid source structure 22 is depicted schematically, but in practice it may be constituted by suitable piping, valving, and manifolding associated with a secondary fluid supply tank and pumps, compressors, or other motive fluid drivers producing a flow of pressurized secondary drying fluid introduced to the puffer jets 20 in the secondary fluid feed lines 24.

At the upper end of the spray drying vessel 14, an inlet 26 is provided, to which the spray-dryable liquid flavor composition to be spray-dried in the spray drying vessel 14 is flowed in liquid composition feed line 40 under the action of liquid flavor composition pump 38 receiving the liquid flavor composition in liquid flavor composition supply line 36 from the liquid composition supply vessel 28. The liquid flavor composition to be spray-dried may be formulated in the liquid flavor composition supply vessel 28, to which ingredient of the liquid flavor composition may be supplied for mixing therein, e.g., under the action of a mixer device internally disposed in the liquid composition supply vessel 28 (not shown in FIG. 1). Such mixer device may be or include a mechanical mixer, static mixer, ultrasonic mixer, or other device effecting blending and homogenization of the liquid flavor composition to be subsequently spray-dried.

For example, when the liquid composition to be spray-dried is a slurry or emulsion of solvent, carrier, and product flavor material, the solvent may be supplied to the liquid flavor composition supply vessel 28 from a solvent supply vessel 30, carrier material may be provided to the liquid composition supply vessel 28 from a carrier material supply vessel 32, and product flavor material may be provided to the liquid flavor composition supply vessel 28 from a product flavor material supply vessel 34, as shown.

The liquid flavor composition to be spray-dried thus is flowed from the liquid composition supply vessel 28 through liquid flavor composition supply line 36 to pump 38, and then flows under action of such pump in liquid flavor composition feed line 40 to the inlet 26 of the spray drying vessel 14 to a spray device such as an atomizer or nozzle disposed in the inlet region of the interior volume of the spray drying vessel. Concurrently, main drying fluid is flowed in main drying fluid feed line 70 to the inlet 26 of the spray drying vessel 14, for flow through the interior volume of the spray drying vessel from the upper cylindrical portion 18 thereof to the lower conical portion 16 thereof, at the lower end of which the dried powder product and effluent drying fluid flow into the effluent line 42. During flow of the main drying fluid through the interior volume of the spray drying vessel 14, the puffer jets 20 are selectively actuated to introduce secondary drying fluid at suitable pressure and flow rate to induce localized turbulence throughout the interior volume, in the drying fluid flow stream, for enhancement of mass transfer and drying efficiency of the spray drying vessel.

The dried encapsulated flavor powder product and effluent drying fluid flowing in the effluent line 42 pass to the cyclone separator 44, in which the dried encapsulated flavor powder solids are separated from the effluent drying fluid, with the separated encapsulated flavor powder solids passing in product feed line 46 to the dried encapsulated flavor powder product collection vessel 48. The dried encapsulated flavor powder product in the collection vessel 48 may be packaged in such vessel, or may be transported to a packaging facility (not shown in FIG. 8) in which the collected dried encapsulated flavor powder product is packaged in bags, bins, or other containers for shipment and ultimate use.

The effluent drying fluid separated from the dried encapsulated flavor powder product in the cyclone separator 44 flows in effluent fluid feed line 52 the baghouse 52 in which any residual entrained fines in the effluent fluid are removed, to produce a fines-depleted effluent fluid that then is flowed in effluent fluid transfer line 54 to blower 56, from which the effluent fluid is flowed in blower discharge line 58 to the condenser 60 in which the effluent fluid is thermally conditioned as necessary, with the thermally conditioned effluent fluid than being flowed in recycle line 62 to blower 64, from which the recycled effluent fluid flows in pump discharge line 66 to dehumidifier 68 in which residual solvent vapor is removed to adjust the relative humidity and dew point characteristics of the drying fluid to appropriate levels for the spray drying operation, with the dehumidified drying fluid then flowing in main drying fluid feed line 70 to the inlet 26 of the spray drying vessel 14, as previously described.

The dehumidifier may in various embodiments be constructed and arranged to provide both the primary drying fluid and the secondary drying fluid to the spray drying vessel 14 at a predetermined relative humidity and dew point characteristic, or multiple dehumidifiers may be provided in the spray drying system for such purpose.

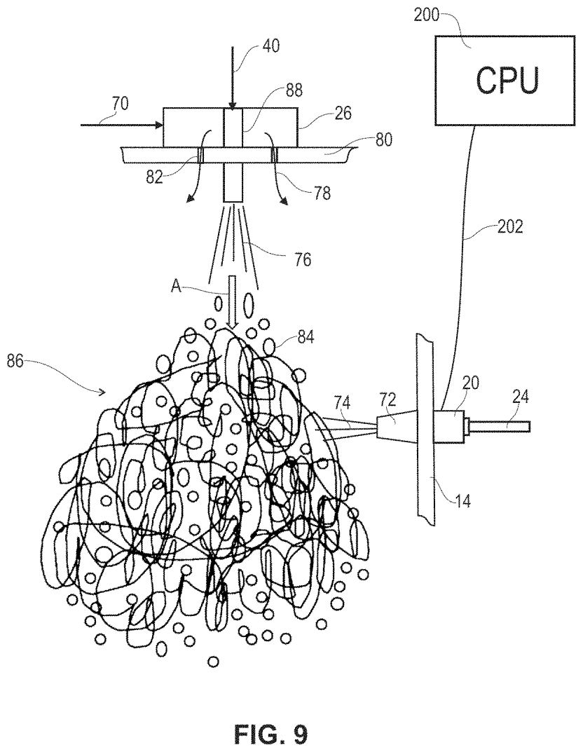

FIG. 9 is a schematic representation, in breakaway view, of a portion of the spray drying process system of FIG. 8, showing the action of localized turbulence induction in the interior volume of the spray drying vessel in the spray drying system.

As depicted, the inlet 26 of the spray dryer 14 includes a top wall 80 on which the inlet 26 is reposed, receiving main drying fluid in main drying fluid feed line 70, and spray-dryable liquid flavor composition in liquid flavor composition feed line 40. In the inlet, the introduced spray-dryable liquid flavor composition flows into the atomizer nozzle 88 extending through the top wall 80, and is discharged at the open lower end of such nozzle as an atomized spray 76 of liquid droplets 84 that fall through the interior volume of the spray drying vessel 14, in the direction indicated by arrow A, while being contacted with the main drying fluid introduced from main drying fluid feed line 70 to the inlet 26, for flow through openings 82 in the top wall 80, with the main drying fluid then flowing downwardly as indicated by arrows 78, so that the co-currently introduced main drying fluid and atomized liquid flavor composition droplets 84 are contacted with one another.

The drying fluid introduced to the interior volume of the spray drying vessel 14 may be introduced in such manner as to induce significant turbulence in the inlet region of the spray drying vessel, which is augmented by the injection of secondary drying fluid to induce localized turbulence throughout the interior volume of the spray drying vessel during the contacting of drying fluid with the atomized liquid flavor composition droplets.

Accordingly, during such contacting of the main drying fluid and droplets of the atomized spray-dryable liquid flavor composition, the puffer jet 20 may be actuated by an actuation signal transmitted in signal transmission line 202 from CPU 200, to initiate injection of secondary drying fluid supplied in the in the secondary fluid feed line 24 from the distal nozzle 72 of the puffer jet, to introduce a turbulent injected flow 74 of secondary drying fluid that in interaction with the main drying fluid flow stream creates a localized turbulence region 86 in the interior volume of the spray drying vessel 14, to enhance mass transfer and drying efficiency.

The CPU 200 thus may be programmably arranged and constructed to actuate the puffer jet 20 intermittently, cyclically and repetitively, to provide a series of bursts of turbulent secondary drying fluid into the main drying fluid flow stream that disruptively and intensively mixes the drying fluid with the droplets of atomized liquid flavor composition, and wherein others of the multiple puffer jets associated with the spray drying vessel 14 may be synchronously or asynchronously actuated in relation to puffer jet 20, in any suitable pattern and timing schedule of “firings” of individual puffer jets in the overall system.

The induction of localized turbulence in the interior volume of the spray drying vessel enables extraordinarily high levels of mass transfer of solvent from the spray-dried flavor composition droplets to the drying fluid in the spray drying operation, enabling minimal spray drying vessel volumes to be utilized for achievement of spray-dried encapsulated flavor powder products, thereby achieving capital equipment, energy, and operating expense reductions. Such advantages are particularly substantial in low temperature spray drying operations, and enable remarkably compact and efficient spray drying process systems to be efficiently utilized in high rate spray drying operations for production of the spray-dried encapsulated flavor powder of the present disclosure.

In the spray drying operation that is carried out to produce the spray-dried encapsulated flavor powder, any suitable drying fluid may be employed that produces a spray-dried encapsulated flavor powder product meeting the powder product characteristics described herein. While air is preferred in many embodiments to produce the spray-dried encapsulated flavor powder, the drying fluid in other embodiments may comprise oxygen, oxygen-enriched air, nitrogen, helium, argon, neon, carbon dioxide, carbon monoxide, or other fluid species, including single component fluids, as well as fluid mixtures. The drying fluid may in various embodiments exist in a gaseous or vapor form, and the fluid should be constituted and flowed through the spray drying vessel at process conditions that provide an appropriate mass transfer driving force for passage of solvent or other desirably volatilizable material from the spray of spray-dried flavor composition material to the drying fluid. Solvents used in the spray-dryable liquid flavor compositions may be of any suitable type and may for example include water, inorganic solvents, organic solvents, and mixtures, blends, emulsions, suspensions, and solutions thereof. In various embodiments, organic solvents may be employed, such as for example acetone, chloroform, methanol, methylene chloride, ethanol, dimethyl formamide (DMF), dimethyl sulfoxide (DMS), glycerine, ethyl acetate, n-butyl acetate, and mixtures with water of the one or more of the foregoing. In specific embodiments, solvent selected from the group consisting of water, alcohols, and water-alcohol solutions may be advantageously employed.

The carrier material that is used in the spray-dryable liquid flavor composition to encapsulate the flavor components may be of any suitable type, and may for example be selected from among carbohydrates, proteins, lipids, waxes, cellulosic material, sugars, starches, natural and synthetic polymeric materials, and mixtures of two or more of the foregoing. Preferred carriers include starch carriers, sugar carriers, and cellulosic carriers.

When the spray-dryable liquid flavor composition comprises a slurry or emulsion of carrier, flavor component, and solvent, the viscosity of the slurry material may be controlled by appropriate formulation so that at the time of spray drying of the liquid flavor composition, the viscosity is advantageously in a range of from 300 mPa-s (1 mPa-s=1 centipoise) to 28,000 mPa-s or more. In various other applications, the viscosity may be in a range in which a lower limit of the range is any one of 325, 340, 350, 375, 400, 450, 500, 550, 600, 650, 700, 750, 800, 850, 900, 950, and 1000 mPa-s, and in which an upper limit of the range is greater than the lower limit and is any one of 400, 450, 500, 550, 600, 650, 700, 750, 800, 850, 900, 950, 1000, 2000, 3000, 4000, 5000, 6000, 7000, 8000, 9000, 10,000, 11,000, 12,000, 13,000, 14,000, 15,000, 16,000, 17,000, 18,000, 19,000, and 20,000, with any viscosity ranges comprising any one of such lower limits and any one of such upper limits being usefully employed in various specific applications. A preferred viscosity range in some applications is from 500 to 16,000 mPa-s, and a preferred viscosity range in other applications is from 1000 to 4000 mPa-s.

In various embodiments, the ratio of solvent within the spray-dryable slurry or emulsion is desirably controlled so that the ratio of solvent within the slurry at the spray drying operation does not exceed 50% by weight, based on total weight of the slurry (emulsion). For example, in various applications, the ratio of solvent in the slurry at the spray drying step may be from 20 to 50 weight percent, or from 20 to 45 weight percent, or from 20 to 40 weight percent, or from 25 to 35 weight percent, on the same total weight basis, as appropriate to the specific spray drying operation and flavor components and other materials involved.

The temperature of the drying fluid that is introduced into the spray drying vessel, as measured at the inlet of the spray drying vessel (inlet temperature of drying fluid flowed to the spray drying vessel) is below 110° C. In various applications, the inlet temperature of the drying fluid may be controlled to be below 100° C., 95° C., 90° C., 85° C., 80° C., 75° C., 70° C., 65° C., 60° C., 55° C., 50° C., 45° C., 40° C., 35° C., 30° C., 25° C., or 20° C., as appropriate to the specific spray drying operation involved. As shown in the graphical comparison of FIG. 1, the “constant” rate period in low temperature spray drying is very short or nonexistent due to the initial low solvent concentration of the slurry or emulsion, so that drying is controlled almost from the outset by diffusion from the inner particle core through a porous drying layer to produce fully dense dry powder product without hollow regions or shell structures. When localized turbulence induction is used in such low temperature process, a high concentration gradient between the sprayed particle (droplet) surface and the surrounding drying fluid is achieved.

In the spray drying operation, it is necessary to appropriately control the relative humidity of the drying fluid, to carry out the spray drying process so as to yield the spray-dried encapsulated flavor powder of the desired character. In various embodiments, the drying fluid flowed into the spray drying chamber may have a relative humidity that does not exceed 35%, 30%, 25%, 20%, 15%, 12%, 10%, 8%, 6%, 5%, 4%, 3%, 2.5%, 2%, 1.8%, 1.6%, 1.5%, 1.4%, 1.3%, 1.2%, 1.1%, 1.0%, 0.9%, 0.8%, 0.7%, 0.6%, 0.5%, 0.4%, 0.3%, 0.2%, 0.1%, 0.05%, 0.02%, or 0.01%.

In various embodiments, the relative humidity of the stream of drying fluid flowed into the spray drying chamber may be in a range in which the lower end point of the range is any one of 10⁻⁴%, 10⁻³%, 10⁻²%, 10⁻¹%, 1%, 1.5%, or 2%, and in which the upper end point of the range is greater than the lower end point of the range, and is any one of 35%, 30%, 20%, 15%, 12%, 10%, 8%, 6%, 5%, 4%, 3%, 2.5%, 2%, 1.8%, 1.6%, 1.5%, 1.4%, 1.3%, 1.2%, 1.1%, 1.0%, 0.9%, 0.8%, 0.7%, 0.6%, 0.5%, 0.4%, 0.3%, 0.2%, 0.1%, 0.05%, 0.02%, 0.01%, or 0.05%. For example, the stream of drying fluid flowed into the spray drying chamber may have a relative humidity in a range of 10⁻⁴% to 35%, 10⁻³% to 18%, 0.005 to 17%, 0.01% to 15%, 0.01 to 5%, 0.1 to 5%, or 0.001% to 2%.

As another option that may be useful to enhance the spray drying operation for production of the spray-dried encapsulated flavor powder, the spray drying process may further comprise applying an electrohydrodynamic charge (typically referred to misnomerically as electrostatic charge, with corresponding spray drying commonly referred to as electrostatic spray drying) to at least one of the spray-dryable liquid flavor composition and the atomized spray of liquid flavor composition particles, for electrohydrodynamic spray drying of the spray-dryable liquid flavor composition. Such electrohydrodynamic spraying operation may be carried out at any suitable voltage conditions appropriate to the specific application in which electrohydrodynamic spraying is employed. In various embodiments, the electrohydrodynamic charge may be in a range of from 0.25 to 80 kV although it will be appreciated that higher or lower electrohydrodynamic charge may be imparted to the flavor composition material to be spray-dried in specific applications. In various embodiments, electrohydrodynamic charge imparted to the particles being spray-dried may be in a range of from 0.5 to 75 kV, or from 5 to 60 kV, or from 10 to 50 kV, or in other suitable range or other specific value.

In other embodiments of electrohydrodynamic spray drying, the feedstock liquid flavor composition may be sprayed through an electrohydrodynamic nozzle operatively coupled with a voltage source arranged to apply a cyclically switched voltage to the nozzle, e.g., between high and low voltages that are within any of the above-discussed, or other, voltage ranges.

Post atomization charging ofthe spray-dryable flavor composition droplets may be carried out with corona discharge-type atomizers which use an external electrode with the nozzle grounded, or, if the conductivity characteristics ofthe spray-dryable flavor composition droplets are favorable, such post atomization charging may be carried out with electron beam irradiation of the atomized droplets.

Thus, electrohydrodynamic charging of the spray-dryable liquid flavor composition may be carried out before, during, or after atomization of such flavor composition. Electrohydrodynamic spraying equipment of widely varying types may be utilized in the electrohydrodynamic spraying systems and operations, e.g., an electrohydrodynamic spraying device positioned to introduce an electrohydrodynamically charged spray of the spray-dryable liquid flavor composition into the interior volume of a spray drying vessel for contacting with the drying fluid therein.

The generation of the spray of spray-dryable liquid flavor composition for contacting with the drying fluid may be effected with any suitable apparatus, including atomizers, nebulizers, ultrasonic dispersers, centrifugal devices, nozzles, or other appropriate devices. The liquid flavor composition may be introduced into the interior volume of the spray drying vessel in a liquid film or ligament form that is broken up to form droplets. A wide variety of equipment and techniques is able to be utilized to form the spray of liquid composition in the form of droplets or finely divided liquid particles. For example, droplet size and distribution may be fairly constant in a given spray drying system, and droplets may be in a range of 10-300 μm, or other suitable range

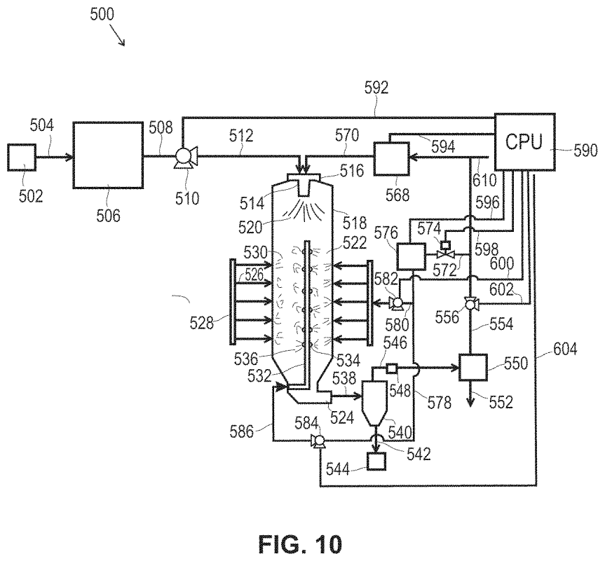

FIG. 10 is a schematic representation of another spray drying apparatus that may be employed to produce the encapsulated flavor spray-dried powder of the present disclosure, in which the apparatus includes an array of turbulent mixing nozzles on the spray drying chamber wall, configured for injection of transient, intermittent turbulent air bursts into the main fluid flow in the spray drying chamber.

As shown, the spray drying system 500 includes a feedstock precursor flavor composition source 502, from which a feedstock precursor flavor composition is flowed in feed line 504 to a feedstock composition processing unit 506, in which the precursor flavor composition is processed or treated to yield the spray-dryable liquid flavor composition. Such upstream processing unit may be of any suitable type, and may for example comprise a concentration unit in which the product material to be spray-dried is concentrated from a feedstock precursor flavor composition concentration to a higher concentration in the spray-dryable liquid flavor composition discharged from the unit in line 508.

The spray-dryable liquid flavor composition is flowed from the feedstock flavor composition processing unit 506 in liquid flavor composition feed line 508 by pump 510 to feedstock feed line 512, from which it flows into the spray dryer inlet 516 of the spray dryer vessel 518, and thereupon is atomized by the atomizer 514 to generate an atomized spray 520 of the spray-dryable liquid flavor composition. Concurrently, conditioned drying fluid is flowed in conditioned drying fluid feed line 570 to the inlet 516 of the spray dryer vessel 518, so that the introduced conditioned drying fluid flows through the interior volume 522 of the spray dryer vessel 518, for contact with the atomized spray of spray-dryable liquid flavor composition.

The conditioned drying fluid, or any portion thereof, may be flowed through the atomizer 514, in a so-called two-fluid atomization, or the conditioned drying fluid may be flowed into the interior volume 522 of the spray drying vessel 518 as a separate stream, in relation to the introduction of the spray-dryable liquid composition and its passage through the atomizer 514.

The atomizer 514 may be of any suitable type, and may for example include any of rotary atomizers, centrifugal atomizers, jet nozzle atomizers, nebulizers, ultrasonic atomizers, etc., and combinations of two or more of the foregoing. The atomizer may be electrohydrodynamic to carry out electrohydrodynamic spray drying of the concentrated feedstock composition, as previously described, or the atomizer may be non-electrohydrodynamic in character.

Regardless of the specific atomizer type and mode of atomization employed, the atomized spray 520 of feedstock composition is introduced to the interior volume 522 of the spray drying vessel 518, and the atomized droplets of the spray-dryable liquid composition are contacted with the conditioned drying fluid during their passage through the interior volume to the spray dryer outlet 524, to dry the atomized droplets and produce the spray-dried encapsulated flavor powder product.

The spray drying vessel 518 may optionally be provided with auxiliary drying fluid peripheral feed lines 526, in which the arrowheads of the respective schematic feed lines 526 designate injector jets arranged to introduce auxiliary drying fluid into the interior volume 522 of the spray drying vessel 518. The feed lines 526 and injector jets thereof thus may pass through corresponding wall openings in the spray drying vessel 518 so that the injector jets are internally arrayed, or the injector jets may be arranged so that they communicate with wall openings in the spray drying vessel, injecting auxiliary drying fluid therethrough into the interior volume 522. The auxiliary drying fluid may be introduced into the interior volume of the spray drying vessel at sufficient pressure and flow rate to generate localized turbulence 530 at or near the point of introduction into the interior volume of the spray drying vessel.

The auxiliary drying fluid peripheral feed lines 526 are illustrated as being coupled with an auxiliary drying fluid manifold 528 through which the auxiliary drying fluid is flowed to the respective feed lines 526. The auxiliary drying fluid may be introduced into the interior volume of the spray drying vessel in a continuous manner, or in an intermittent manner. The auxiliary drying fluid may be introduced in bursts, e.g., in a time-sequenced manner, and the injector jets may be programmably arranged under the monitoring and control of a central processor unit such as the CPU 590 illustrated in FIG. 10.

Such localized induction of turbulence enhances the diffusivity and mass transfer of liquid solvent from the atomized droplets of concentrated feedstock flavor composition to the drying fluid present in the spray drying vessel.

The spray drying vessel 518, as a further enhancement of the drying of the atomized droplets of concentrated feedstock flavor composition in the interior volume of the vessel, may be equipped with an auxiliary drying fluid central feed line 532 as shown. The auxiliary drying fluid central feed line 532 is provided with a series of longitudinally spaced-apart auxiliary drying fluid central feed line injector jets 534, in which auxiliary drying fluid may be injected under sufficient pressure and flow rate conditions to generate auxiliary drying fluid injected turbulence regions 536.

The auxiliary drying fluid introduced into the interior volume of the spray drying vessel through the feed lines 526 and associated injector jets may be introduced into the interior volume of the spray drying vessel in a continuous manner, or in an intermittent manner from the injector jets 534, to provide auxiliary drying fluid injected turbulence regions 536 at a central portion of the interior volume 522 in the spray drying vessel. The auxiliary drying fluid may be introduced through the central feed line injector jets 534 in bursts, e.g., in a time-sequenced manner, and the injector jets may be programmably arranged under the monitoring and control of a central processor unit such as the CPU 590 illustrated in FIG. 10.

A combination of peripheral jets and central jets such as shown in FIG. 10 may be used to provide localized turbulence throughout the interior volume of the spray dryer vessel, in the central region as well as the outer wall region of the interior volume, to carry out a spray drying process in which anomalous flow behavior, such as dead zones or stagnant regions in the interior volume, is minimized. A highly favorable hydrodynamic mass transfer environment is correspondingly provided to prepare spray-dried encapsulated flavor powders having the characteristics variously described herein.

The spray-dried encapsulated flavor powder and effluent drying gas that are produced by the contacting of the atomized droplets of concentrated feedstock flavor composition with drying fluid in the interior volume of the spray dryer vessel, are discharged from the spray dryer vessel in spray dryer outlet 524 and flow in spray dryer effluent line 538 to cyclone 540. In lieu of cyclone equipment, any other suitable solids/gas separation unit of appropriate character may be employed. The cyclone 540 separates dried encapsulated flavor solids from the drying fluid, with the dried encapsulated flavor solids flowing in dried solids discharge line 542 to a dried solids collection vessel 544. The drying fluid depleted in solids content flows from the cyclone in drying fluid discharge line 546, flowing through fines filter 548 to condenser 550. In the condenser 550, the drying fluid is cooled, resulting in condensation of condensable gas therein, with condensate being discharged from the condenser in condensate discharge line 552.

The resulting condensate-depleted drying fluid then flows in drying fluid recycle line 554 containing pump 556 therein to the drying fluid conditioning assembly 568, together with any needed make-up drying fluid introduced in drying fluid make-up feed line 610. The drying fluid conditioning assembly conditions the recycle drying fluid and any added make-up drying fluid for flow to the spray dryer vessel 518 in conditioned drying fluid feed line 570. The drying fluid conditioning assembly may comprise a dehumidifier and/or heat exchange (heater/cooler) equipment to provide drying fluid for recycle at appropriate desired conditions of temperature and relative humidity.

Thus, drying fluid, including any necessary make-up drying fluid, may be provided to the drying fluid conditioning assembly 568, or otherwise provided to the spray drying system at other appropriate location(s) in the system, from an appropriate source, and with any appropriate preconditioning operations being carried out by associated equipment or devices, as needed to conduct the spray drying operation at the desired temperature, pressure, flow rate, composition, and relative humidity. Thus, for example, make-up drying fluid may be provided to the conditioning assembly 568 from a tank, storage vessel, or other source (e.g., the ambient atmosphere, in the case of air as such drying fluid).

As a source of auxiliary drying fluid in the system, a portion of the recycled drying fluid from drying fluid recycle line 554 may be diverted in auxiliary drying fluid feed line 572 containing flow control valve 574, to the auxiliary drying fluid conditioning assembly 576. The auxiliary drying fluid conditioning assembly 576 may be constructed and arranged in any suitable manner, and may be of a same or similar character to the construction and arrangement of the drying fluid conditioning assembly 568. The auxiliary drying fluid conditioning assembly 576 thus conditions the auxiliary drying fluid so that it is at appropriate condition for the use of the auxiliary drying fluid in the system.

The conditioned auxiliary drying fluid flows from auxiliary drying fluid conditioning assembly 576 through auxiliary drying fluid feed line 578, from which it flows in auxiliary drying fluid feed line 580 containing pump 582 to the manifold 528, while the remainder of the conditioned auxiliary drying fluid flows in auxiliary drying fluid feed line 578 to pump 584, from which it is flowed in auxiliary drying fluid feed line 586 to the auxiliary drying fluid central feed line 532, for introduction in the central region of the interior volume of the spray dryer vessel, as previously described.

It will be recognized that the system shown in FIG. 10 could be alternatively constructed and arranged with the drying fluid conditioning assembly 568 processing both the main flow of drying fluid and the auxiliary drying fluid, without the provision of a separate auxiliary drying fluid conditioning assembly 576, e.g., when the main drying fluid and auxiliary drying fluid are of a substantially same character with respect to their relevant fluid characteristics. It will also be recognized that separate flow circulation loops for each of the main drying fluid and auxiliary drying fluid may be provided, when the main drying fluid and auxiliary drying fluid are or comprise different gases, or are otherwise different in their relevant fluid characteristics.

The FIG. 10 system is shown as including a central processor unit (CPU) 590 arranged to conduct monitoring and/or control operations in the system, and when employed in a controlling aspect, may be employed to generate control signals for modulation of equipment and/or fluids conditions, to maintain operation at set point or otherwise desired operational conditions. As mentioned, the CPU could be operationally connected to the conditioning assemblies 568 and 576, to control components thereof such as dehumidifiers, thermal controllers, heat exchange equipment, etc.

The CPU 590 is illustratively shown in FIG. 10 as being operatively coupled by monitoring and/or control signal transmission lines 592, 594, 596, 598, 600, 602, and 604 with pump 510, drying fluid conditioning assembly 568, auxiliary drying fluid conditioning assembly 576, flow control valve 574, pump 582, pump 556, and pump 584, respectively.

It will be recognized that the specific arrangement of the CPU shown in FIG. 10 is of an illustrative character, and that the CPU may be otherwise arranged with respect to any components, elements, features, and units of the overall system, including the concentration unit 506, to monitor any suitable operational components, elements, features, units, conditions, and parameters, and/or to control any suitable operational components, elements, features, units, conditions, parameters, and variables. For such purpose, as regards monitoring capability, the system may comprise appropriate sensors, detectors, components, elements, features, and units. The signal transmission lines may be bidirectional signal transmission lines, or may constitute cabling including monitoring signal transmission lines and separate control signal transmission lines.

It will be appreciated that the spray drying system may be embodied in arrangements in which the contacting gas, auxiliary contacting gas, drying fluid, and auxiliary drying fluid, or any two or more thereof, may have a substantially same composition, temperature, and/or relative humidity, thereby achieving capital equipment and operating cost efficiencies with corresponding simplification of the system requirements. Thus, for example, all of the contacting gas, auxiliary contacting gas, drying fluid, and auxiliary drying fluid may be air, nitrogen, argon, or other gas from a common gas source, and such common gas may be provided at a substantially same temperature and relative humidity, so that common thermal conditioning and dehumidification equipment can be employed.

The FIG. 10 system thus provides a spray drying system of higher efficiency in which localized turbulence induction throughout the interior volume of the spray drying vessel may be employed to produce the high-performance spray-dried encapsulated flavor powders of the present disclosure, having specific powder characteristics that may be achieved by corresponding selection of process operating conditions.

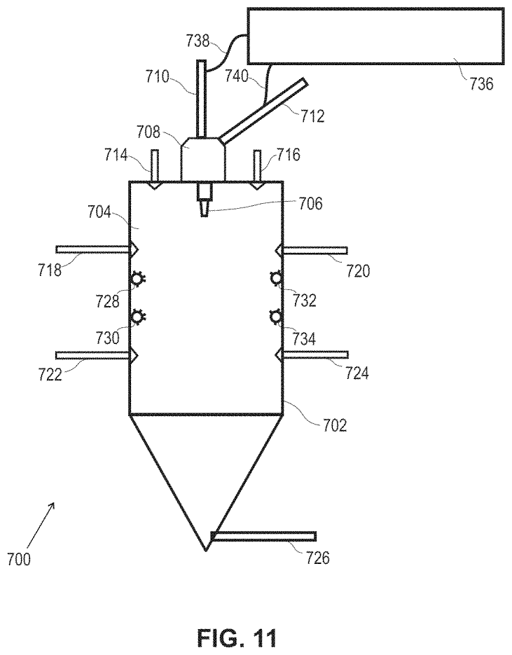

FIG. 11 is a schematic representation of a further spray drying apparatus that may be employed to produce the encapsulated flavor spray-dried powders of the present disclosure.

The spray drying system 700 shown in FIG. 11 includes a spray drying vessel 702 with interior volume 704. In the interior volume is disposed an atomizer 706 depending downwardly from inlet feed assembly 708. The inlet feed assembly 708 includes spray-dryable flavor composition feed line 710 and drying fluid feed line 712, arranged so that the spray-dryable flavor composition is flowed from a suitable source (not shown in FIG. 11) through feed line 710 to the atomizer 706. The atomizer operates to generate an atomized spray-dryable composition discharged into the interior volume 704 of the spray dryer vessel 702. The drying fluid feed line 712 flows drying fluid from a source (not shown) through the inlet feed assembly 708 to the interior volume 704 of the spray dryer vessel 702.

The spray dryer vessel 702 is equipped with a plurality of jet nozzle injectors 714, 716, 718, 720, 722, and 724, each having a feedline joined to a source of secondary drying fluid. The jet nozzle injectors inject the secondary drying fluid at suitable flow rate and pressure conditions to induce turbulence in the primary drying fluid in the interior volume 704.

In addition to the jet nozzle injectors, the spray dryer vessel 702 also includes a series of wall-mounted turbulators 728, 730, 732, and 734, which are sized and shaped to cause turbulence in the drying fluid contacting them during flow of the drying fluid through the interior volume of the vessel. At the lower end of the conical lower portion of the vessel is an effluent discharge line 726, by which spray-dried encapsulated flavor powder and effluent drying fluid are discharged from the vessel.

The turbulators shown in FIG. 11 are devices that are configured to induce turbulence in the drying fluid being contacted with the atomized spray-dryable material. The devices may be of any suitable type, and may include any one or more jets, nozzles, injectors, and the like that are utilized for injection of secondary drying fluid into a body of primary drying fluid so as to induce turbulence in the drying fluid for enhancement of the spray-drying operation. The devices may alternatively be of a structural type that in interaction with the drying fluid induces turbulence in the drying fluid, e.g., twisted tapes, static mixer devices, airfoils, Brock turbulators, wire turbulators, coil turbulators, and wall protrusion turbulators. Various kinds of such devices may be combined with one another in various embodiments, as may be desirable to achieve suitable intensity of turbulence for enhancement of the rate and/or extent of drying of the atomized spray-dryable flavor composition.

The spray-dried material and effluent drying fluid may be passed to a cyclone separator in which the spray-dried encapsulated flavor powder is recovered from the effluent drying fluid, with the effluent drying fluid then being processed for recycle in the system, in whole or part, if desired, or alternatively being vented from the system, with fresh drying fluid being introduced as above described.

The spray drying system shown in FIG. 11 further comprises a process control unit 736 that is shown schematically with process control signal transmission lines 738 and 740, thereby schematically signifying that the process control unit is operatively linked with the delivery lines so as to regulate the flow rate of drying fluid into the interior volume and flow rate of the spray-dryable flavor material to the atomizer so that interaction of the drying fluid with the at least one turbulator produces turbulence in the drying fluid, e.g., turbulence having a Kolmogorov length less than average particle size of spray-dryable material droplets in the atomized spray-dryable material in the interior volume of the vessel. Such arrangement may thus include respective flow control valves in the spray-dryable flavor composition feed line 710 and drying fluid feedline 712 for such purpose.

The above-mentioned Kolmogorov length, η, is defined by the equation

$$η = \sqrt[1 / 4]{\frac{{v}^{3}}{ɛ}} ,$$

where v is the kinematic viscosity of the drying fluid, and ε is the rate of dissipation of kinetic energy in the induced turbulence in the drying fluid.

The Kolmogorov length may be utilized to characterize the turbulence that is induced in the spray drying operation by jets or other turbulator components associated with the spray drying vessel. The Kolmogorov length characterizes the energy dissipating eddies in the turbulence that is induced in the fluid flow in the interior volume of the spray drying vessel. The turbulent kinetic energy in such flow can be described in terms of a kinetic energy cascade that develops spatiotemporally in the fluid in the interior volume of the spray drying vessel after turbulence is initiated. The energy introduced into the fluid in the spray drying vessel, by fluid injection or by flow disruption, generates hydrodynamic instabilities at large scales, typically characterized as the integral scale. The energy at the integral scale then is transferred to progressively smaller scales, initially through inviscid mechanisms such as vortex stretching, and subsequently through viscous dissipation into heat. When graphically shown on a logarithmic plot of energy as a function of wave number, the discrete regimes of an initial energy-containing range reflecting the induced turbulence, followed by an inertial range, followed by a final dissipation range are readily visualized as depicting an energy cascade, with large eddies at the low wave number region transforming to ever smaller eddies and ultimately dissipating into heat. The scale at which the dissipative decay begins is the Kolmogorov scale

$$η = \sqrt[1 / 4]{\frac{{v}^{3}}{ɛ}}$$

wherein ε is the turbulence 0dissipation rate shown in the logarithmic plot and v is the kinematic viscosity of the drying fluid.

The turbulent dissipation rate and Kolmogorov length are readily determined using standard hot wire anemometry or laser Doppler anemometry techniques. For example, hot wire anemometry may be employed to generate values of turbulence power density at a range of frequencies, with a log-log plot of turbulence power density as a function of frequency, in Hertz, depicting the induced turbulence, inertial range, and dissipation range of the cascade, and with the dissipation range values enabling the turbulence dissipation rate to be determined, from which Kolmogorov length can be calculated from the above Kolmogorov scale formula.

Advantageously, for producing spray-dried encapsulated flavor powders having the characteristics variously discussed herein, turbulence may be induced in at least 5 volume % of the volume of drying fluid in the interior volume of the vessel to provide substantial enhancement of the spray-drying operation. More generally, the turbulence may be induced in at least 5, 10, 15, 20, 25, 30, 35, 40, 45, 50, 55, 60, 65, 70, 75, 80, 85, 90, 95, or more volume % of the volume of drying fluid in the interior volume of the vessel. Thus, it is advantageous to maximize the amount of the drying fluid in which turbulence is induced, and the volumetric proportion of the drying fluid in the interior volume of the vessel in which turbulence is induced may beneficially include the drying fluid that is in contact with the atomizer, so that turbulence is induced as soon as possible as the drying fluid is introduced and contacted with the atomized spray-dryable flavor composition.

In the FIG. 11 apparatus, the process control unit 736 may be adapted to regulate flow rate of drying fluid into the interior volume and flow rate of the spray-dryable material to the atomizer so that the average particle size of the spray-dryable flavor material droplets in the atomized spray-dryable flavor material in the interior volume of the vessel is in a range of from 50 to 300 μm, or in other droplet size range.

Additionally, or alternatively, the process control unit may be adapted to regulate flow rate of drying fluid into the interior volume and flow rate of the spray-dryable flavor composition material to the atomizer so that turbulence dissipation rate of the induced turbulence in the interior volume of the spray drying vessel exceeds 25 m²/sec³. For such purpose, the process control unit may comprise microprocessor(s), microcontroller(s), general or special purpose programmable computer(s), programmable logic controller(s), or the like, which are programmatically arranged for carrying out the spray drying process operation by means of appropriate hardware, software, or firmware in the process control unit. The process control unit may comprise memory that is of random-access, read-only, flash, or other character, and may comprise a database of operational protocols or other information for operational performance of the system.

Accordingly, there exists a variety of spray drying systems and apparatus, and a corresponding variety of processing methods and techniques that may variously be employed to produce spray-dried encapsulated flavor powders of the present disclosure, having the attributes and characteristics described herein.

For this purpose, the spray drying operation may be conducted within the various operating conditions and parameters described herein, while selectively varying the same in conformity with the specific structure and configuration of the spray drying systems and apparatus employed, to empirically determine a suitable process envelope of operating conditions for producing the spray-dried encapsulated flavor powders of the present disclosure, e.g., single-step spray-dried encapsulated flavor powders, including one or more encapsulated flavor ingredients, and characterized by one or more, and preferably all, of the characteristics of:
(A) a Dispersing Medium Dissolution Time of less than 60 seconds;
(B) a Dispersing Medium Dispersion Time of less than 15 seconds;
(C) a Particle Size Distribution in which at least 75% of particles in the powder have a particle size of at least 80 μm;
(D) a Surface Area (μm²) To Volume (μm³) Ratio of the particles of the powder that is in a range of from 0.01 to 0.03;
(E) a Particle Void Volume in the particles of the powder that is less than 10% of the total particle volume;
(F) a Bulk Density of the particles of the powder that is in a range of from 22 to 40 lb/ft³, and
(G) an Angle Of Repose of the powder that does not exceed 40°, optionally wherein when the spray-dried powder contains an encapsulated oil, the Surface Oil Percentage is less than 1.5%.

Further, while illustrative flavor species of almond, orange, lemon, lime, tangerine, amaretto, anise, pineapple, coconut, pecan, apple, banana, strawberry, cantaloupe, caramel, cherry, blackberry, raspberry, ginger, boysenberry, blueberry, vanilla, honey, molasses, wintergreen, cinnamon, cloves, butter, buttercream, butterscotch, coffee, tea, peanut, cocoa, nutmeg, chocolate, cucumber, mint, toffee, eucalyptus, grape, raisin, mango, peach, melon, kiwi, lavender, licorice, maple, menthol, passionfruit, pomegranate, dragon fruit, pear, walnut, peppermint, pumpkin, root beer, rum, and spearmint have been variously identified in the preceding disclosure, it will be recognized that numerous other flavors and flavor blends are amenable to in spray-dried encapsulated flavor powders of the present disclosure, providing the superior retention levels and other high-performance characteristics variously described herein.

The spray-dried encapsulated flavor powder of the present disclosure, including one or more encapsulated flavor ingredients, may therefore in various embodiments be characterized by the following characteristics:

(A) a Dispersing Medium Dissolution Time of less than 60 seconds;

(B) a Dispersing Medium Dispersion Time of less than 15 seconds;

(C) a Particle Size Distribution in which at least 75% of particles in the powder have a particle size of at least 80 μm;

(D) a Surface Area (μm²) To Volume (μm³) Ratio of the particles of the powder that is in a range of from 0.01 to 0.03;

(E) a Particle Void Volume in the particles of the powder that is less than 10% of the total particle volume;

(F) a Bulk Density of the particles of the powder that is in a range of from 22 to 40 lb/ft³, and

(G) an Angle Of Repose of the powder that does not exceed 40°,

optionally wherein when the spray-dried powder contains an encapsulated oil, the Surface Oil Percentage is less than 1.5%,

and such spray-dried encapsulated flavor powder may additionally be characterized by any one or more of the following characteristics (1)-(31):

(1) the one or more encapsulated flavor ingredients comprises at least one selected from the group consisting of almond, orange, lemon, lime, tangerine, amaretto, anise, pineapple, coconut, pecan, apple, banana, strawberry, cantaloupe, caramel, cherry, blackberry, raspberry, ginger, boysenberry, blueberry, vanilla, honey, molasses, wintergreen, cinnamon, cloves, butter, buttercream, butterscotch, coffee, tea, peanut, cocoa, nutmeg, chocolate, cucumber, mint, toffee, eucalyptus, grape, raisin, mango, peach, melon, kiwi, lavender, licorice, maple, menthol, passionfruit, pomegranate, dragon fruit, pear, walnut, peppermint, pumpkin, root beer, rum, and spearmint;

(2) the one or more encapsulated flavor ingredients is encapsulated by a carrier material comprising at least one selected from the group consisting of carbohydrates, proteins, lipids, waxes, cellulosic material, sugars, starches, natural and synthetic polymeric materials;

(3) the one or more encapsulated flavor ingredients is encapsulated by a carrier material comprising at least one selected from the group consisting of maltodextrin, corn syrup solids, modified starches, gum arabic, modified celluloses, gelatin, cyclodextrin, lecithin, whey protein, and hydrogenated fat;

(4) the one or more encapsulated flavor ingredients is encapsulated by a carrier material comprising a modified starch;

(5) the one or more encapsulated flavor ingredients comprises at least one flavor oil;

(6) the spray-dried encapsulated flavor powder of claim 1 comprises a single-step spray-dried encapsulated flavor powder;

(7) the spray-dried encapsulated flavor powder is characterized by a Dispersing Medium Dissolution Time that is less than at least one of 45, 40, 35, 30, 25, 20, 15, 12, 10, 8, 7, 6, and 5 seconds;

(8) the spray-dried encapsulated flavor powder is characterized by a Dispersing Medium Dispersion Time of less than at least one of 15, 14, 13, 12, 11, 10, 9, 8, 7, 6, 5, 4, 8, 2, and 1 second(s);

(9) the spray-dried encapsulated flavor powder is characterized by a Particle Size Distribution in which at least one of 80%, 85%, 88%, 90%, 91%, 92%, 93%, 94%, and 95% of particles in the powder have a particle size of at least 80 μm;

(10) the spray-dried encapsulated flavor powder is characterized by a Particle Size Distribution in which at least 80% of particles in the powder have a particle size of at least 80 μm;

(11) the spray-dried encapsulated flavor powder is characterized by a Particle Size Distribution in which at least 85% of particles in the powder have a particle size of at least 80 μm;

(12) the spray-dried encapsulated flavor powder is characterized by a Particle Size Distribution in which at least 90% of particles in the powder have a particle size of at least 80 μm;

(13) the spray-dried encapsulated flavor powder is characterized by a Particle Void Volume that is less than at least one of 10%, 9%, 8%, 7%, 6%, 5%, 4%, 3%, 2.5%, 2%, and 1%, of the total particle volume;

(14) the spray-dried encapsulated flavor powder is characterized by a Particle Void Volume that is less than 2.5% of the total particle volume;

(15) the spray-dried encapsulated flavor powder is characterized by a Particle Void Volume that is less than 2% of the total particle volume;

(16) the spray-dried encapsulated flavor powder is characterized by a Bulk Density of the particles of the powder that is in a range of from 25 to 38 lb/ft³,

(17) the spray-dried encapsulated flavor powder is characterized by an Angle of Repose of the powder that does not exceed 35°;

(18) the spray-dried encapsulated flavor powder is characterized by an Angle of Repose of the powder that does not exceed 30°;

(19) the particles in the powder are free of large-scale voids therein;

(20) the particles in the powder are of non-spherical form;

(21) the particles in the powder are of elongate form;

(22) the powder has an average eccentricity of at least 0.7;

(23) the powder has an average eccentricity in a range of from 0.70 to 0.95;

(24) the powder has an average eccentricity in a range of from 0.75 to 0.95;

(25) the powder has an average eccentricity in a range of from 0.80 to 0.95;

(26) the spray-dried encapsulated flavor powder is characterized by a Particle Size Distribution in which at least 80%, 85%, 88%, 90%, 91%, 92%, 93%, 94%, or 95% of particles in the powder have a particle size of at least 85 μm, 90 μm, 95 μm, 100 μm, 110 μm, or 120 μm;

(27) the spray-dried encapsulated flavor powder is characterized by a Particle Size Distribution in which at least 80%, 85%, 88%, 90%, 91%, 92%, 93%, 94%, or 95% of particles in the powder have a particle size in a range whose endpoints are any of 80 μm, 85 μm, 90 μm, 95 μm, 100 μm, 110 μm, and 120 μm, with the proviso that the lower end point value of such range is less than the upper end point value of such range;

(28) the spray-dried encapsulated flavor powder is characterized by a median particle size that is greater than 100 μm;

(29) the spray-dried encapsulated flavor powder is characterized by an average particle size that is greater than 100 μm;

(30) the one or more encapsulated flavor ingredients comprises a flavor oil; and

(31) the spray-dried encapsulated flavor powder is characterized by a flavor component retention level that is at least one of 90%, 91%, 92%, 93%, 94%, 35%, 96%, 97%, 98%, 98.5%, 99%, 99.5%, and 99.9%, based on weight of the flavor component in spray-dryable material from which the spray-dried encapsulated flavor powder is produced, with particularly preferred embodiments including characteristic (31) with any one or more of the characteristics (1) to (30).

Accordingly, while the disclosure has been set forth herein in reference to specific aspects, features and illustrative embodiments, it will be appreciated that the utility of the disclosure is not thus limited, but rather extends to and encompasses numerous other variations, modifications and alternative embodiments, as will suggest themselves to those of ordinary skill in the field of the present disclosure, based on the description herein. Correspondingly, the invention as hereinafter claimed is intended to be broadly construed and interpreted, as including all such variations, modifications and alternative embodiments, within its spirit and scope.

1. A spray-dried encapsulated flavor powder including one or more encapsulated flavor ingredients, and characterized by the following characteristics:
(A) a Dispersing Medium Dissolution Time of less than 60 seconds;
(B) a Dispersing Medium Dispersion Time of less than 15 seconds;
(C) a Particle Size Distribution in which at least 75% of particles in the powder have a particle size of at least 80 μm;
(D) a Surface Area (μm²) To Volume (μm³) Ratio of the particles of the powder that is in a range of from 0.01 to 0.03;
(E) a Particle Void Volume in the particles of the powder that is less than 10% of the total particle volume;
(F) a Bulk Density of the particles of the powder that is in a range of from 22 to 40 lb/ft³, and
(G) an Angle Of Repose of the powder that does not exceed 40°,
optionally wherein when the spray-dried powder contains an encapsulated oil, the Surface Oil Percentage is less than 1.5%.

2. The spray-dried encapsulated flavor powder of claim 1, wherein the one or more encapsulated flavor ingredients comprises at least one selected from the group consisting of almond, orange, lemon, lime, tangerine, amaretto, anise, pineapple, coconut, pecan, apple, banana, strawberry, cantaloupe, caramel, cherry, blackberry, raspberry, ginger, boysenberry, blueberry, vanilla, honey, molasses, wintergreen, cinnamon, cloves, butter, buttercream, butterscotch, coffee, tea, peanut, cocoa, nutmeg, chocolate, cucumber, mint, toffee, eucalyptus, grape, raisin, mango, peach, melon, kiwi, lavender, licorice, maple, menthol, passionfruit, pomegranate, dragon fruit, pear, walnut, peppermint, pumpkin, root beer, rum, and spearmint.

3. The spray-dried encapsulated flavor powder of claim 1, wherein the one or more encapsulated flavor ingredients is encapsulated by a carrier material comprising at least one selected from the group consisting of carbohydrates, proteins, lipids, waxes, cellulosic material, sugars, starches, natural and synthetic polymeric materials.

4. The spray-dried encapsulated flavor powder of claim 1, wherein the one or more encapsulated flavor ingredients is encapsulated by a carrier material comprising at least one selected from the group consisting of maltodextrin, corn syrup solids, modified starches, gum arabic, modified celluloses, gelatin, cyclodextrin, lecithin, whey protein, and hydrogenated fat.

5. The spray-dried encapsulated flavor powder of claim 1, wherein the one or more encapsulated flavor ingredients is encapsulated by a carrier material comprising a modified starch.

6. The spray-dried encapsulated flavor powder of claim 1, wherein the one or more encapsulated flavor ingredients comprises at least one flavor oil.

7. The spray-dried encapsulated flavor powder of claim 1, comprising a single-step spray-dried encapsulated flavor powder.

8. The spray-dried encapsulated flavor powder of claim 1, characterized by at least one of: (i) a Dispersing Medium Dissolution Time that is less than at least one of 45, 40, 35, 30, 25, 20, 15, 12, 10, 8, 7, 6, and 5 seconds; and (ii) a Dispersing Medium Dispersion Time of less than at least one of 15, 14, 13, 12, 11, 10, 9, 8, 7, 6, 5, 4, 8, 2, and 1 second(s).

9. (canceled)

10. The spray-dried encapsulated flavor powder of claim 1, characterized by a Particle Size Distribution in which at least one of 80%, 85%, 88%, 90%, 91%, 92%, 93%, 94%, and 95% of particles in the powder have a particle size of at least 80 μm.

11.-13. (canceled)

14. The spray-dried encapsulated flavor powder of claim 1, characterized by a Particle Void Volume that is less than at least one of 10%, 9%, 8%, 7%, 6%, 5%, 4%, 3%, 2.5%, 2%, and 1%, of the total particle volume.

15.-16. (canceled)

17. The spray-dried encapsulated flavor powder of claim 1, characterized by a Bulk Density of the particles of the powder that is in a range of from 25 to 38 lb/ft³.

18. The single-step spray-dried encapsulated flavor powder of claim 1, characterized by an Angle of Repose of the powder that does not exceed 35°.

19. (canceled)

20. The spray-dried encapsulated flavor powder of claim 1, wherein the particles in the powder are free of large-scale voids therein.

21. The spray-dried encapsulated flavor powder of claim 1, wherein the particles in the powder are of non-spherical form.

22. The spray-dried encapsulated flavor powder of claim 1, wherein the particles in the powder are of elongate form.

23. The spray-dried encapsulated flavor powder of claim 1, wherein the powder has an average eccentricity of at least 0.7.

24. The spray-dried encapsulated flavor powder of claim 1, wherein the powder has an average eccentricity in a range of from 0.70 to 0.95.

25.-26. (canceled)

27. The spray-dried encapsulated flavor powder of claim 1, characterized by a Particle Size Distribution in which at least 80%, 85%, 88%, 90%, 91%, 92%, 93%, 94%, or 95% of particles in the powder have a particle size of at least 85 μm, 90 μm, 95 μm, 100 μm, 110 μm, or 120 μm.

28. The spray-dried encapsulated flavor powder of claim 1, characterized by a Particle Size Distribution in which at least 80%, 85%, 88%, 90%, 91%, 92%, 93%, 94%, or 95% of particles in the powder have a particle size in a range whose endpoints are any of 80 μm, 85 μm, 90 μm, 95 μm, 100 μm, 110 μm, and 120 μm, with the proviso that the lower end point value of such range is less than the upper end point value of such range.

29. The spray-dried encapsulated flavor powder of claim 1, characterized by a median particle size that is greater than 100 μm.

30. The spray-dried encapsulated flavor powder of claim 1, characterized by an average particle size that is greater than 100 μm.

31. (canceled)

32. A spray-dried encapsulated flavor powder according to claim 1, characterized by a flavor component retention level that is at least one of 90%, 91%, 92%, 93%, 94%, 35%, 96%, 97%, 98%, 98.5%, 99%, 99.5%, and 99.9%, based on weight of the flavor component in spray-dryable material from which the spray-dried encapsulated flavor powder is produced.
